(19) United States
(12) Patent Application Publication
(10) Pub. No.: US 2004/0248515 A1
(43) Pub. Date: Dec. 9, 2004

(54) Multi-user detection

(76) Inventor: Arkady Molev Shteiman, Bnei-Brak (IL)

Correspondence Address: William H Dippert, Reed Smith, 29th Floor, 599 Lexington Avenue, New York, NY, 10022-7650, US

(21) Appl. No.: 10/488,675

(22) PCT Filed: Sep. 3, 2002
(86) PCT No.: PCT/IL02/00726

(30) Foreign Application Priority Data
Sep. 3, 2001 (IL) 145245
Jun. 10, 2002 (IL) 150133

(51) Int. Cl. H04B 7/005; H04B 7/01; H04B 7/015; H04B 15/00

(52) U.S. Cl. 455/63.1; 455/501

(57) ABSTRACT

A method of finding a maximum likelihood solution for, comprising: providing a sample vector; iteratively match-filtering said sample vector with a coefficient matrix to find a gradient; using the gradient to search for a maximum likelihood solution; and deciding if a found solution of vector data is good enough.

### FIELD OF THE INVENTION

This invention is in the field of signal processing, in particular methods of reducing interference between multiple users of a communication channel.

### BACKGROUND OF THE INVENTION

Consider a communication system comprising p channels carrying digital signals X={X₁, X₂, . . . Xₚ}, with each Xᵢ equal to +1 or −1. There are also q received samples Y={Y₁, Y₂, . . . Y_{q}}, where q is typically greater than p. Among other possibilities, the different channels could represent different frequency bands, or different time slots in a shared frequency band, or the channels could be defined by Code Division Multiple Accesses (CDMA), in which each of p channels is associated with a different one of p different orthogonal binary codes, each p bits long. In general there is receiver noise in each channel described by a vector N={N₁, N₂, . . . N_{q}}, and there is attenuation or amplification in each channel, and cross-talk between channels, described by the elements Aᵢⱼ of a channel matrix A. Then we may write

Y=A·X+N (1)

If there is not much cross-talk, then A is nearly diagonal. We wish to find the most likely values of the components Xᵢ of the transmitted channel vector X, given known values of Y and A. In many cases, A is also not known, or not known very precisely, and we wish to use the observed values of Y to estimate A as well as X.

If the noise is Gaussian, then the most likely X is the one which minimizes |Y−A·X|. If A is diagonal, then sgn(A⁻¹·Y) is the most likely X. If A is not square, we use sgn((A^{T}A)⁻¹A^{T}Y). Also, if A is diagonal then A^{T}A will also be diagonal, with each diagonal element equal to the absolute value squared of the corresponding element of A, i.e., all of the diagonal elements of A^{T}A will be positive. So each element of A^{T} will have the same sign (or phase, if it is complex) as the corresponding element of A⁻¹, and sgn(A⁻¹·Y), the most likely X, may also be expressed as sgn(A^{T}·Y). This is known as the Single User Maximum Likelihood solution, since it neglects cross-talk. If A has known off-diagonal elements that are not negligible, then the most likely X (the Multi User Maximum Likelihood solution) is the one which minimizes (Y−A·X)^{T}·(Y−A·X). Since, even in the binary case there are 2^{P} possible solutions X, it is not practical to try them all when p is large. In some cases it is desirable to have an iterative procedure which converges on the solution.

One approach is to calculate

V=A^{T}·Y−(R−R_{D})·X (2)

using an initial guess for X, and then use sgn(V) as a guess for X in the next iteration. Here R=A^{T}A, and R_{D} is the diagonal part of R. If R−R_{D} is not too great, then this procedure will converge. But if R is too far from being diagonal and/or in other cases, the procedure may not converge or converge to a wrong answer. Another disadvantage of this procedure is that R is expensive to evaluate because it involves multiplying two non-diagonal matrixes, A^{T} and A, and this matrix multiplication must be done repeatedly if we wish to track A as it changes with time.

The implementation of this procedure is shown in a flow diagram in FIG. 1A. An input 100 of sample vector Y is multiplied at 102 by the match filter A^{T}, which is found at 104 by taking the transpose of the channel matrix A, also read in as input 105. In parallel with this, at 106, the channel matrix A is multiplied by its transpose A^{T} to produce the matrix R, and at 108, the diagonal elements of R are zeroed to produce the off-diagonal matrix R−R_{D}. At 110, the current estimate of the transmitted channel vector X is multiplied by the off-diagonal matrix R−R_{D}. Initially, a guess for X is read in as input 109. At 112, the result, (R−R_{D})·X, is subtracted from A^{T}·Y, to find vector V. At 114, V is used to produce a new estimate for X by setting each component of X equal to the sign of the corresponding component of V. At 116, a comparison is made of the new estimate for X found at 114, and the previous estimate of X. If the two are equal, then this is the Multi User Maximum Likelihood solution, and this X is sent to output at 118. If X is still changing, then the new estimate for X is used to calculate (R−R_{D})·X in 110, and the loop continues until X converges.

### SUMMARY OF THE INVASION

An aspect of some embodiments of the invention concerns using an iterative procedure for searching for a Multi User Detection solution, for example for a Maximum Likelihood solution X, that does not require the repeated multiplication of two matrixes, or repeated inverting a matrix, but only repeated addition of matrixes, or repeated multiplication of a matrix by a vector, and/or repeated calculating the diagonal elements of the product of two matrixes. Such operations require on the order of p² arithmetic operations, while finding all the elements of the product of two matrixes, or inverting a matrix, requires on the order of p³ arithmetic operations. In an exemplary embodiment of the invention, the problem to be solved is a search for a the Multi User Maximum Likelihood solution for a transmitted channel vector X, with known received sample vector Y and channel matrix A, in the presence of noise, and with interference between the different channels, i.e. with off-diagonal terms in A. For example, the number of users can be 10, 20, 40, 100 or more, with some of the users having more than one path, for example, two, three, four or more paths. Optionally, as will be described below, for example, multiple bits are extracted simultaneously for at least some of the users. In an exemplary embodiment of the invention, a general expression for at least some such an iterative procedure is (e.g., using a hard decision search method):

X_{new}=sgn(X_{old}+M·(Y−A·X_{old})) (3)

where M is a p×q matrix which may depend on A. Eq. (3) has the property that X will not change from one iteration to the next if it satisfies Y−A·X=0. This is a desirable condition for such an iterative converging procedure to have, since any X which satisfies Y−A·X=0 must be the Multi User Maximum Likelihood solution, although usually, because of noise, the Multi User Maximum Likelihood solution will not satisfy Y−A·X=0. Also, Eq. (3), unlike Eq. (2), does not require multiplying of matrixes, as long as calculating M does not require multiplying of matrixes.

Eq. (3) may not always converge on the Multi User Maximum Likelihood solution with any choice of M. For example, if all the elements of M are sufficiently small, then Eq. (3) will never move from the initial guess for X. If the elements of M are too large, then Eq. (3) may not converge at all, but may get stuck in an endless loop between different values of X. In order to choose a suitable matrix M, we note that using

M=R_{D}⁻¹·A^{T} (4)

in Eq. (3) will cause it to converge in one iteration, if R=A^{T}·A is diagonal, i.e. if R=R_{D}. In this case, the Multi User Maximum Likelihood solution is sgn(A^{T}·Y). Thus, using Eq. (4) for M, the right hand side of Eq. (3) will always be equal to the Multi User Maximum Likelihood solution, regardless of the initial guess X_{old}. If R is not diagonal, then these results will not generally be true. Nevertheless, if cross-talk isn't too severe, so that R has a somewhat predominant diagonal part, then we expect that Eq. (3) with Eq. (4) may often be a fairly efficient iterative procedure for converging on the Multi User Maximum Likelihood solution.

In an exemplary embodiment of the invention, instead of calculating M, Eq. (3) is multiplied by R_{D}, yielding:

X_{new}=sgn(R_{D}X_{old}+A^{T}·(Y−A·X_{old})) (5)

Since R_{D} is diagonal, positive and non-zero, its effect on X_{new} is optionally ignored.

In an exemplary embodiment of the invention, what is provided is a generalized gradient finding system (e.g., formed of hardware or a hardware/software combination), which may be used for various applications and/or in conjunction with various search strategies and need not be application specific, for example by allowing the storing of generalized matrixes. Such a component, may be provided, for example as a board or an integrated component, optionally with a software media, for example including plurality of possible search routines with which it may be programmed. In an exemplary embodiment of the invention, the gradient finder is implemented using a matrix-vector multiplier. In an exemplary embodiment of the invention, the gradient finder is used in a cellular telephone receiver, for example as part of a base station or for cross-talk cancellation in a DSL receiver. It should be noted that while a maximum likelihood solution is searched for, in many cases the solution that is found is only approximate. Exemplary search methods include searching using a hard decision and searching using a soft decision.

In an exemplary embodiment of the invention, a gradient G (e.g., ∂h/∂X) that is calculated by the generalized gradient finding system is 2A^{T}(Y−AX_{old}) where the factor of two is optionally ignored in some embodiments of the invention. h is the minimization object.

In an exemplary embodiment of the invention, the gradient finder comprises a match filter and an estimator, and one or both is programmable, rather than implemented as a non-programmable unit. In an exemplary embodiment of the invention, programming is by changing a software function. Optionally, a system is provided with multiple such functions which may be selected, for example as needed or during calibration or setting up of the system for use (e.g., in a base station). In one example, different estimation, match filtering and/or decision logics are used, depending on a noise level and/or number of users and/or type of transmissions and/or type of inference.

An aspect of some embodiments of the invention relates to an iterative method of finding a multi-user detection solution, in which a step of match filtering is inside the iteration, rather than outside.

An aspect of some embodiments of the invention relates to dynamic adjustment of matrix convergence parameters in a gradient search, for example, the convergence of a coefficient for a matrix A and/or or a convergence coefficient of data X. In an exemplary embodiment of the invention, the adjustment is made responsive to a degree of noise, with larger amounts of noise indicating a smaller convergence parameter. Alternatively or additionally to parameter convergence, in an exemplary embodiment of the invention, large changes in a coefficient matrix are detected and corrected for by a method other than iterative convergence, or using markedly different convergence factors.

An aspect of some embodiments of the invention relates to separating out contributions from a plurality of users, when the users are not synchronized, in the presence of echoes and/or in the presence of various types of inter-symbol inference. In an exemplary embodiment of the invention, a bit is sent as a set of chips. Two bits from different users can have a total length of more than two bits, for example, if there is very little overlap and there is some echo at the end of the overlap. In an exemplary embodiment of the invention, the above method of maximum likelihood determination is applied to input data at steps of one bit (theoretical size, without channel effects), with results from a previous application of the method used, to the extent that they overlap. A matrix used for this application has a height of the maximum number of chips that contribute to a data bit, e.g., twice the bit length plus the multipath length; and a width of the number of channels. While this matrix may be used as is for the next overlapping series of samples, optionally, this matrix is adapted based on previous results of its application.

In an exemplary embodiment of the invention, when this method is applied using a matrix vector multiplier with a limited length, the data in the multiplier is shifted (e .g., one chip set at a time) between applications, while the loaded matrix remains the same and/or is changed for adaptation.

It should be noted that the overlap may be more than one bit length.

An aspect of some embodiments of the invention relates to applying frustrated convergence for user contribution separation. In an exemplary embodiment of the invention, a series weighted average of the right hand side of Eq. (3) and the previous X for the new value of X is used when iterating, instead of using the right hand side of Eq. (3) for the new value of X. This procedure may be useful, for example, if an estimated correction may include a significant noise component that cause divergence of the solution.

It should be appreciated that at any iteration before the end of the procedure, the elements of X will not necessarily be +1 or −1 (even if these are the only correct values). In an exemplary embodiment of the invention, a soft decision method is applied, in which at least some values are allowed to stay non integer between iterations, for example (−0.5 . . . 0.5). Optionally, a limit is applied, for example truncating values with an absolute value greater than 1. Values between 1 and −1 (and outside the above non-integer range) are optionally rounded to the nearest integer. At the end, a hard decision is optionally applied, where all values are rounded to either +1 or −1.

This iterative procedure will potentially converge more slowly than the Hard Decision iterative procedure when R−R_{D} is small, but may expand the range of R−R_{D} and possibly N over which convergence occurs. Generally, the greater the weight given to the previous X in this weighted average, the more slowly the estimate of X will tend to converge when R−R_{D} is small, but the greater will be the range of R−R_{D} over which convergence occurs at all. Optionally, the relative weight given to the right hand side of Eq. (3) and the previous X are adjusted dynamically, as A and/or N changes in time, so that X converges to the Multi User Maximum Likelihood solution about as quickly as possible.

In an exemplary embodiment of the invention, a soft decision is applied during iteration and a hard decision is applied on the final result.

An aspect of some embodiments of the invention relates to a method of matrix tracking, in which a byproduct of the use of the matrix is used for tracking. In an exemplary embodiment of the invention, an error value is used as part of a main process to determine a likely set of data from samples, for example for a match filter. This error value is used to update the matrix. Optionally, the error is added using a weight, for example to prevent noise from causing divergence in the tracking.

An aspect of some embodiments of the invention relates to a method of using a matrix-vector multiplier, where the matrix is a convolution of a known component and an unknown component, in which the known component is loaded into the matrix for calculation and then the result is convoluted with the unknown component. In an example of CDMA, a matrix (each line thereof) is a convolution of a known user code and an unknown impulse response. The calculations are performed using a relatively smaller (e.g., with no over-sampling) known code matrix and then the result is oversampled and convoluted with the impulse response. Alternatively, it may be first convoluted and then oversampled, or the two steps may be done together.

There is thus provided in accordance with an exemplary embodiment of the invention, a method of finding a maximum likelihood solution for, comprising:

providing a sample vector;

iteratively match-filtering said sample vector with a coefficient matrix to find a gradient;

using the gradient to search for a maximum likelihood solution; and

deciding if a found solution of vector data is good enough. Optionally, deciding comprises deciding using a soft decision method. Alternatively or additionally, said solution is used to solve a multi-user detection (MUD) problem. Optionally, said MUD is for cellular telephony.

In an exemplary embodiment of the invention, said vector includes contributions from at least 20 independent signal sources. Optionally, said at least 20 independent signal sources comprises at least 40 such sources. Alternatively or additionally, each of said sources provides at least two dependent signals. Alternatively or additionally, each of said sources provides at least three dependent signals.

In an exemplary embodiment of the invention, said searching uses frustrated convergence.

In an exemplary embodiment of the invention, said method uses less than o(n\hat{ }3) operations, where n is the size of the sample vector.

In an exemplary embodiment of the invention, the method comprises tracking changes in said coefficient matrix.

In an exemplary embodiment of the invention, the method comprises estimating a signal using said coefficient matrix.

In an exemplary embodiment of the invention, match-filtering comprises match-filtering using vector-matrix multiplication. Optionally, the method comprises arranging said data to fit a specific hardware adapted for vector matrix multiplication. Optionally, arranging comprises arranging said data in a manner which minimizes matrix replacements.

There is also provided in accordance with an exemplary embodiment of the invention, a method of separating out, from a set of samples, signals that are unsynchronized and include echoes and/or other inter-symbol interference, comprising:

first processing a first portion of said samples to yield a first set of values for said signals, at least one of said values not being decidable from said samples;

second processing a second, overlapping portion of said signals to yield a second set of values for said signals, said second processing taking into account said first set of values to correct for an effect of echoes of said first set of values on said second set of values,

wherein each of said processings is performed as a simultaneous block processing. Optionally, processing comprises multiplying by a coefficient matrix. Optionally, the same matrix is used for both processings. Alternatively or additionally, an updated matrix is used for the second processing.

In an exemplary embodiment of the invention, said values are encoded as a series of chips in said signals. Alternatively or additionally, said signals are CDMA cellular telephone signals. Alternatively or additionally, not all signals use the same number of chips to encode a value.

There is also provided in accordance with an exemplary embodiment of the invention, a method of tracking a coefficient matrix, comprising:

providing a coefficient matrix;

calculating an error vector for a data vector X, when using said matrix; and

calculating a correction matrix to be a conjugation of said error vector and a transpose of said data vector X;

setting a new value of said matrix to be an element by element sum of an old values of said matrix and said correction matrix, said correction matrix being multiplied by a correction factor beta. Optionally, at least one of said data vector X and said error vector is substituted by a sign vector of their values.

There is also provided in accordance with an exemplary embodiment of the invention, a method of matrix tracking, comprising:

providing a coefficient matrix;

using said matrix to extract at least an indication of a data vector from a set of samples;

determining an error vector of said use of said matrix, using said indication; and

correcting said matrix using said error vector. Optionally, said indication comprises a gradient. Alternatively, said indication comprises said data vector.

There is also provided in accordance with an exemplary embodiment of the invention, a method of using a coefficient matrix for extracting signals where each signal is encoded using a set of chips and oversampled, comprising:

separating a coefficient matrix into a changing coefficient matrix that includes the inter-signal dependencies and a fixed code matrix which provides over-sampling;

applying a desired processing that requires vector matrix multiplication, using said fixed code matrix; and

perfecting the desired processing by applying said changing coefficient matrix on an element-by-element basis. Optionally, said desired processing comprises signal estimation based on a provided data vector. Alternatively or additionally, said desired processing comprises match filtering of a sample vector. Alternatively or additionally, said desired processing comprises updating said coefficient matrix. Alternatively or additionally, said perfecting comprising applying said changing coefficient matrix on a result of said vector matrix multiplication. Alternatively or additionally, said perfecting comprising applying said changing coefficient matrix on a data vector used for said vector matrix multiplication. Alternatively or additionally, said perfecting comprising updating said changing coefficient matrix using a result of said vector matrix multiplication.

In an exemplary embodiment of the invention, the method comprises providing a new set of data to be processed using said matrix, without updating said matrix as loaded in a vector matrix multiplier.

Optionally, the method comprises padding said fixed code matrix for use with a matrix-vector multiplier. Optionally, the method comprises weighting said fixed code matrix so that longer codes have a smaller weight than shorter codes.

In an exemplary embodiment of the invention, said changing coefficient matrix represents changes in a physical channel of interactions between signal paths represented by said matrix.

There is also provided in accordance with an exemplary embodiment of the invention, a method of finding a set of signal values from a set of data vectors using a coefficient matrix, consisting substantially of:

providing a set of samples; and

applying to said set of samples vector matrix multiplication and element-by-element multiplication and addition and no matrix-matrix multiplication or inversion.

There is also provided in accordance with an exemplary embodiment of the invention, a method of extracting data bits from a set of samples representing the contribution of multiple signals, comprising:

selecting a block of samples; and

processing said block simultaneously to provide a plurality of bits of information for a plurality of signals. Optionally, said plurality of bits comprises over two bits. Alternatively or additionally, said plurality of signals comprises over 10 distinct and substantially independent signals. Alternatively or additionally, said plurality of signals comprises over 30 distinct and substantially independent signals.

In an exemplary embodiment of the invention, at least two of said signals use different temporal lengths to encode said bits.

In an exemplary embodiment of the invention, the method comprises selecting a second block of overlapping samples and processing said block to provide a second plurality of bits of information for said plurality of signals.

Alternatively or additionally, the method comprises:

dividing up input signals based on temporal clustering of the signals, such that each cluster can be processed by a single matrix without requiring matrix changing for a particular hardware implementation; and

processing each such cluster separately.

There is also provided in accordance with an exemplary embodiment of the invention, a generalized gradient finding system, comprising:

an input which receives a set of samples;

a match filter which calculates a gradient based on a coefficient matrix inter-relating the signals that generated the samples; and

a signal estimator which generates an estimated set of samples based on an implementation of said gradient on said samples. Optionally, the system comprises a controller that applies a search method using said gradient.

### BRIEF DESCRIPTION OF THE DRAWINGS

Non-limiting embodiments of the invention will be described with reference to the following description of exemplary embodiments, in conjunction with the figures. The figures are generally not shown to scale and any measurements are only meant to be exemplary and not necessarily limiting. In the figures, identical structures, elements or parts which appear in more than one figure are preferably labeled with a same or similar number in all the figures in which they appear, in which:

FIG. 1A is a flow diagram for converging on the Multi User Maximum Likelihood solution using a prior art method;

FIG. 1B is a flow diagram for a Multi User Detection method used in an exemplary embodiment of the invention;

FIG. 2 is a flow diagram for an algorithm of converging on the Multi User Maximum Likelihood solution, according to an exemplary embodiment of the invention;

FIG. 3 is a flow diagram for monitoring changes in the channel matrix, according to an exemplary embodiment of the invention;

FIG. 4 is a generalized flow diagram for a multi-user detection system, in accordance with an exemplary embodiment of the invention;

FIG. 5 is a schematic illustration of a representation of an asynchronous multi user detection situation, in accordance with an exemplary embodiment of the invention;

FIG. 6 is a schematic illustration based on FIG. 5, indicating overlap during calculation of sequentially arriving data;

FIG. 7 is a schematic illustration of a sample estimator, in accordance with an exemplary embodiment of the invention;

FIG. 8 is a schematic illustration of a match filter, in accordance with an exemplary embodiment of the invention;

FIG. 9 is a schematic illustration of a tracker, in accordance with an exemplary embodiment of the invention;

FIGS. 10A-10C are schematic illustrations of a convolution based match filter, tracker and estimator, in accordance with an exemplary embodiment of the invention;

FIG. 11A is a graph showing the number of iterations required for convergence to within a desired bit error rate, as results of a simulation in accordance with an exemplary embodiment of the invention; and

FIG. 11B is a graph showing a comparison between theory and practice for a plurality of signal separation methods and a method in accordance with an exemplary embodiment of the invention, under a range of signal to noise ratio situations.

### DETAILED DESCRIPTION OF EXEMPLARY EMBODIMENTS

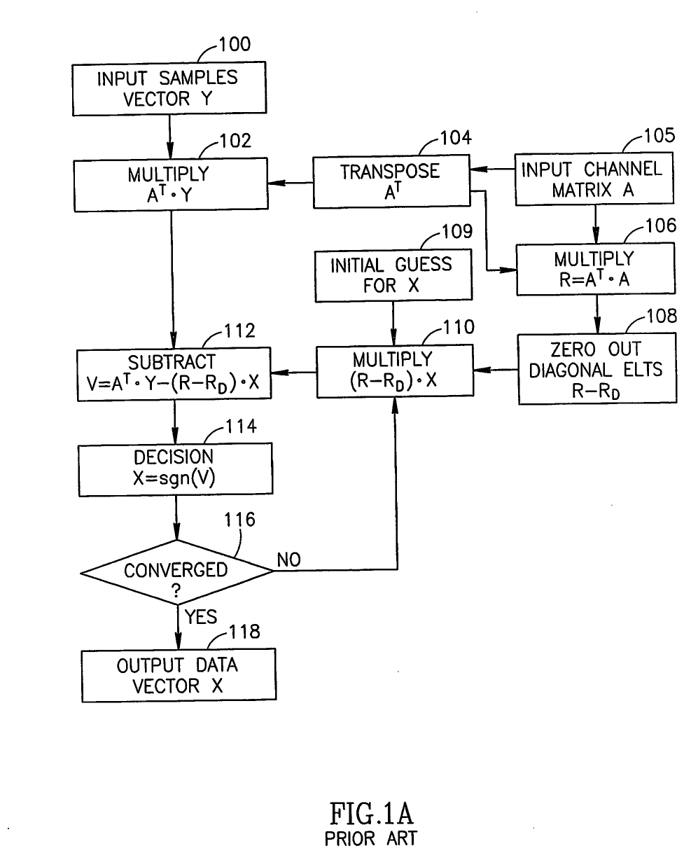

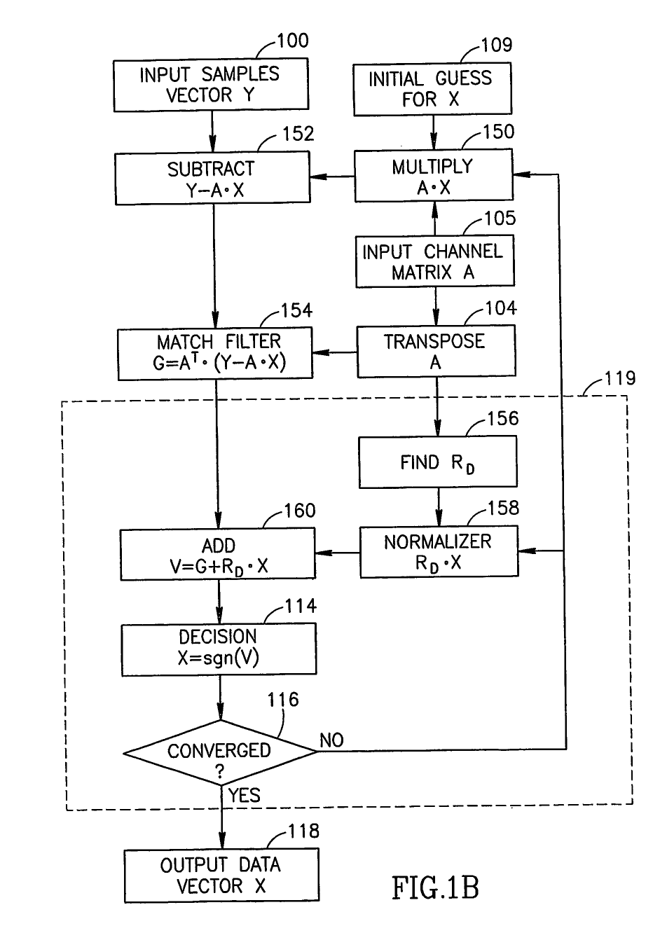

FIG. 1B is a flow diagram showing the procedure used according to an exemplary embodiment of the invention, to search for a the Multi User Maximum Likelihood solution for a transmitted channel vector X, with known received sample vector Y and channel matrix A, in the presence of noise, and with interference between the different channels, i.e. with off-diagonal terms in A.

In FIG. 1B, as in FIG. 1A, the sample vector Y is read in as input at 100, the transpose A^{T} of the channel vector A is found at 104 after A is read as input at 105, and an initial estimate for the channel vector X is read as input at 109. In an exemplary embodiment of the invention, the procedure in FIG. 1B differs from the prior art procedure shown in FIG. 1A, for example, in the way that the vector V is calculated. In FIG. 1B, the current estimate for X is multiplied by A at 150, and subtracted from Y at 152. The difference Y−A·X is multiplied by A^{T} at 154 to find the gradient vector G. The diagonal terms R_{D} of A^{T}·A are found at 156. Then X is multiplied by R_{D} at 158, and the result is added to the gradient vector G at 160, to find the vector V. Alternatively, instead of multiplying X by R_{D} at 158, G is multiplied by R_{D}⁻¹ and the result is added to X at 160 to find V. Since R_{D} is diagonal, it is computationally easy to find its inverse R_{D}⁻¹, and it does not matter if V is redefined as R_{D}⁻¹·V, since all of the diagonal elements of R_{D} are positive, and only sgn(V) is used to find in the next estimate of X. Alternatively, instead of multiplying (Y−A·X) by A^{T} to find the gradient vector G at 154, (Y−A·X) is multiplied by a different matrix. (As noted above, R_{D}⁻¹·A^{T} is only one possible choice for the matrix M in Eq. (3).) As in FIG. 1A, V is used at 114 to find a new estimate for X, which is tested for convergence at 116, and sent to output at 118 if it is converged, or used at 150 and 158 in a new loop if it is not converged. The procedure in FIG. 1B, unlike the procedure in FIG. 1A, does not require the multiplication of two matrixes. At 156, only the diagonal elements of A^{T}·A are found, while in FIG. 1A all the elements of A^{T}·A, or at least all the off-diagonal elements, are found, which is computationally more difficult.

One possible advantage of the method of FIG. 1B, is that if a matrix-vector multiplier is available, it can be used. Another possible advantage is that, separate gradient finder sections and search logic sections may be provided. the dotted line (a reference 119) indicate a search logic section (reference 156 may or may not be part of it), with the elements above the dotted area comprising a gradient finder.

Optionally, instead of requiring complete equality between the new estimate and previous estimate of X, a looser convergence criterion is used at 116. Many such convergence criteria are known in the field of estimation. Alternatively or additionally to using a convergence criterion, the iterations may be limited by a number of repeats. For example, simulation results may show that 10 iterations provide a good results. In this case, the iterations will be repeated 10 times (or limited to 10 times) regardless of convergence. The number of iterations may depend (e.g., and be calibrated for using simulation or real data), for example, on the a fixed criterion. For example, this may be based on noise levels and number of users. Alternatively or additionally, a feedback mechanism may be provided, for example by detecting bits that have a known value, to determine an instant number of iterations to be used.

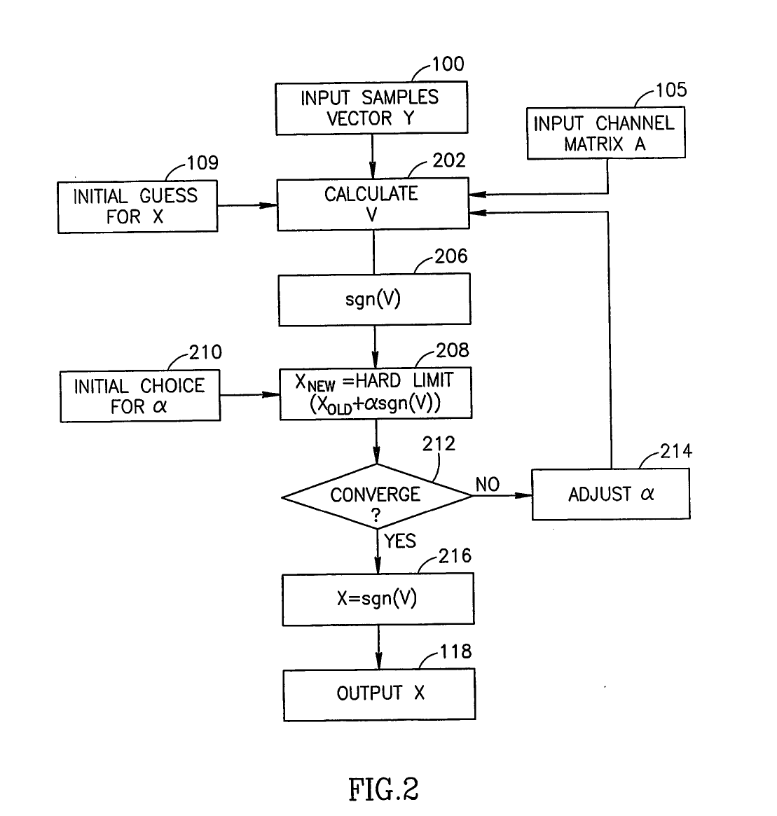

It should be noted that reference 114 shows a hard decision method, however, any other type of decision and/or search method as known in the art or as described below may be used. Optionally, X is estimated at 114 in FIG. 1B the same way as it is estimated in the prior art described in FIG. 1A, by talking the sign of each element of V. This procedure, called “Hard Decision,” has the disadvantage that it may not converge if the off-diagonal terms of R are too large. Alternatively, a different procedure, called “Soft Decision,” is used, as described in FIG. 2. Soft Decision often allows convergence of X for larger off-diagonal elements of R than Hard Decision allows. Optionally, Soft Decision is also used instead of Hard Decision at 114 in the procedure described in FIG. 1A.

In FIG. 2, the sample vector Y is read as input at 100, the channel matrix A is read as input at 105, and an initial estimate for the channel vector X is made at 109. Block 202 in FIG. 2, which reads “Calculate V,” represents blocks 104, 150, 152, 154, 156, 158, and 160 in FIG. 1B, or blocks 102, 104, 106, 108, 110, and 112 in FIG. 1A. At 206, a vector sgn(V) is determined, that is a vector whose elements are either +1 or −1 depending on the sign of the corresponding element of V. At 208, X_{new}, a new estimate of X, is calculated, for example, using a hard limiting function:

X_{new}=HardLimit(X_{old}+α·sgn(V))

Hard limit is a function which truncates all values outside a certain range (e.g., −1 . . . 1) to that range. Another design method which may be used, a hard decision method is X_{new}=sgn (R_{D}X_{old}+G). These decision method may be used, for example, for detection of BPSK (Binary Phase Shift Key) type modulated signals. Other decision methods and/or implementations may be used, for example if there are four or more levels rather than two. Alternatively or additionally, two decision methods may be combined, for example, a fixed or maximum number of iterations may be provided for. Alternatively or additionally, the data may be extracted when it is needed or if the processor is required for other tasks, even if the iterations have not yet converged in a completely satisfactory manner.

An initial choice for the weighting factor a, between 0 and 1, is optionally made at 210. Generally, smaller values of α will allow X to converge when R has relatively larger off-diagonal elements, but will cause X to converge more slowly than with larger α, if R has relatively small off-diagonal elements. A typical value for α might be 0.1. It should be noted that typically α is on the order of 1/(N−1) where N is the number of iterations.

It is important to note that in FIG. 2, unlike in FIG. 1A and FIG. 1B, the estimated X does not generally have elements that are equal only to +1 or −1, but can have elements with any real values between +1 and −1. For this reason, the convergence test at 212 is optionally different from the convergence test used in FIGS. 1A and 1B, which tests to see if the new estimate of X is identical to the old estimate. In FIG. 2, where the elements of X can have any value between +1 and −1, such a stringent test for convergence is unlikely to be satisfied. Instead, the test for convergence optionally requires that changes in the values of each of the elements of X be smaller than some number, perhaps some fraction of α. Alternatively, the convergence test could examine the root mean square change in the elements of X, or some other measure of the overall change in the vector X.

If X has not yet converged, then, at 214, α is optionally adjusted to speed up convergence. Optionally, one or more previous estimates of X are saved, in order to decide whether to increase or decrease α, and by how much. If the elements of X have all kept the same sign for the last few iterations, and have not changed in magnitude by very much, then the speed of convergence may be increased by increasing α. If some of the elements of X keep alternating in sign, between values close to +1 and −1, then convergence is optionally improved by decreasing α.

Once a decision has been made at 212 that X has converged, then at 216 each element of X is set equal to +1 or −1 depending on the sign of the corresponding element in the latest estimate of X, and the resulting channel vector X is output at 118. In an exemplary embodiment of the invention, if other levels (e.g., 2 or more than 2) are used, a hard decision may be made to be limited to the nearest correct value. Similarly, a soft decision may have appropriate ranges defined for it around the correct values. In an exemplary embodiment of the invention, however, the values calculated are adapted to be non-zero and symmetric, for example so that average energy levels in an optical VMM used for processing, are relatively uniform.

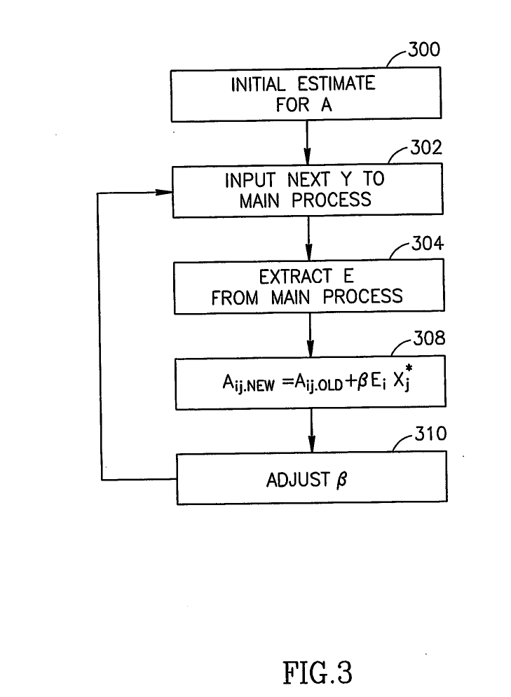

FIG. 3 is a flow diagram describing a procedure for tracking changes in the channel matrix A with time, in which the tracking process uses a value already calculated for the application. At 300, an initial estimate is chosen for A. For example, if the off-diagonal elements of A are known not to be very large, and the diagonal terms are known to be positive, then one possible choice for an initial estimate of A would be to set each diagonal term Aᵢᵢ equal to the absolute value of Yᵢ, and to set the off-diagonal terms equal to zero. This choice for the initial estimate of A may lead to satisfactory convergence and tracking of A even if the off-diagonal terms do not remain small as A evolves, or even if they are not small initially. Alternatively or additionally, A may be estimated by generating an outer vector multiplication between X and Y, with X, for example being a value provided from pilot bits and/or known control bits of a signal. Alternatively or additionally, methods well known in the art may be used for generating such an estimate, for example using a training sequence. In an exemplary embodiment of the invention, the training sequence is data generated using a pseudo-random generator with an agreed upon (between transmitter and receiver) seed.

The sample vector Y is input at 302 and used by the application process. At 304, an error value E, for example, E=Y−Ŷ, is extracted from the main process (the “\hat{ }” symbol marks a variable as an estimate). Then, at 308, the elements Aᵢⱼ of the channel matrix A are updated, by taking a weighted effect of the error value:

A_{new}=A_{old}+βEX^{T}, or A_{ij,new}=A_{ij,old}+βEᵢXⱼ*

,where the weighting factor β is for example between 0 and 1. In an alternative implementation, the following formula is used:

A_{new}=A_{old}+βsgn(E)*sgn(X_{T})

Typically this formula is easier to calculate, and, while less exact, this lack of precision may not pose a problem since β is typically small.

Optionally, at 310, the weighting factor β is adjusted up or down, if A is changing too quickly, or not changing quickly enough. For example, if β is too large and there is a high level of noise, then the estimates of A will have large errors due to noise, and improved accuracy may be obtained by using smaller β. But if the noise level is relatively low and A really is changing relatively rapidly, then using too small a value for β will result in the estimates of A lagging behind the changes in A, and improved accuracy may be obtained by using larger β. For any level of noise, and level and rate of fluctuations in A, there may be an optimum value of β which makes the estimated A (and hence the estimated X) as accurate as possible. To choose this optimum β, it may be usefull to store several past values of A and Y, to determine the level of noise, and the rate of change of A.

Once β is adjusted, the flow then goes back to 302, and a new Y is read in, and the loop repeats. In an exemplary embodiment of the invention, the loop is repeated only once every set of iterations, for example, once a data vector \hat{X} is available and A can be corrected based on it.

Alternatively or additionally to the tracking method shown here, other tracking methods, for example as known in the art, may be used.

In an exemplary embodiment of the invention, notice is taken of the fact that some parts of the detected signals are known a-priori. In an exemplary embodiment of the invention, these known signals are used to monitor the tracking process and/or as a main or only source of data bits to be used for calculating a correction value. These known values are used in the initial guess and may or may not be subject to change during the iteration process.

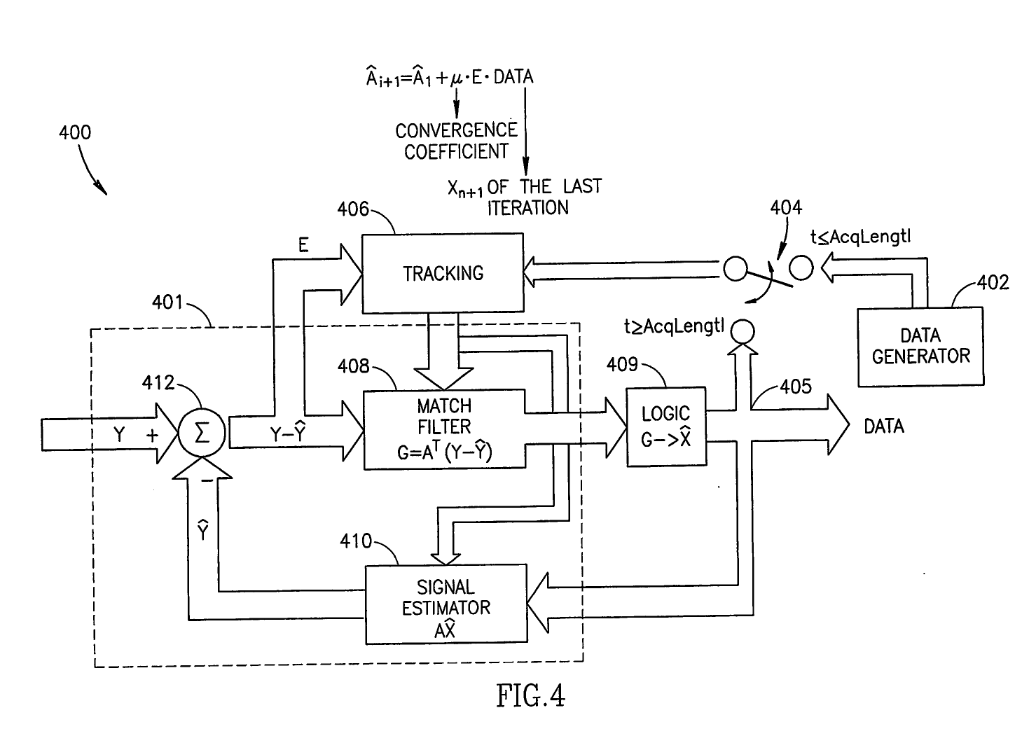

FIG. 4 is a generalized flow diagram for a multi-user detection system 400, in accordance with an exemplary embodiment of the invention. A data generator 402 helps in generating an initial matrix A, for example by providing bits from a learning sequence. In an exemplary embodiment of the invention, the transmitter(s) and receiver(s) (for which users are detected) agree on a random number generator and on a seed to be used, so that they can be synchronized. After a few iterations, a switch 404 selects if the processing of A is sufficient to ensure tracking by a tracking unit 406. While switch 404 is shown in its present location, in an alternative implementation switch 404 is located at a point 405. Optionally, the generated data is also forwarded to a signal estimator (described below).

Samples vector, marked by “Y”, has subtracted from it an estimate of Y, Ŷ, in a unit 412 A match filter unit 408 calculates a gradient G which is passed to a logic unit 409, for generating an estimated \hat{X} and for deciding if the iterations are sufficient or not. If it is, it is outputted, otherwise it is reiterated. For example, \hat{X} may be calculated by setting V=R_{D}*G+X_{old}, and then applying. X_{new}=HardLimit(X_{old}+α·sgn(V)). The estimated \hat{X} maybe calculated at other points in the system instead or in addition to at logic 409.

In an exemplary embodiment of the invention, reference 401 indicates a gradient finding system which may be combined with various logic units 409 of various types, for example, for applying different types of search methods.

A signal estimator 410 is used to estimate a new value for Ŷ based on a currently expected value of \hat{X} (e.g., based on the last determined X_{new}).

In an exemplary embodiment of the invention, when system 400 is turned on, data generator 402 provides pilot bits or other learning sequence data, for initializing A. Then switch 404 is changed, a sample set Y is acquired, multiple iterations are performed and an output vector \hat{X} is provided. In a last iteration, updating of A is performed. For a next sample set, the previous value of A may be used as an initial guess.

In some real-world cases, the transmission of the users are not synchronized, are subject to multi-path and echoes and/or are subject to various inter-symbol inference problems. Thus, for two sets of chips, from different users, there can be a temporal overlap of anywhere between 0% and 100%. In addition, the duration of a set of chips is unknown, due to the echoes. Thus, an effective packet duration T_{Sym}=2Tₚ+T_{H} where Tₚ is the duration of a set of chips (e.g., a packet) and T_{H} is the maximum possible impulse response of the channel (e.g., echo length). With regard to chips, two points may be of interest. First, the actual sampling is typically at a higher rate, for example, at four times the chip rate and any shifting of signals can be in units of ¼ of a chip (or other rate multiplier). In addition different packets can have different spreading factors (SF) and, thus, different lengths. Typically, control data always uses long packers. Content, such as data transmission and voice transmission, may use long packets or short packets.

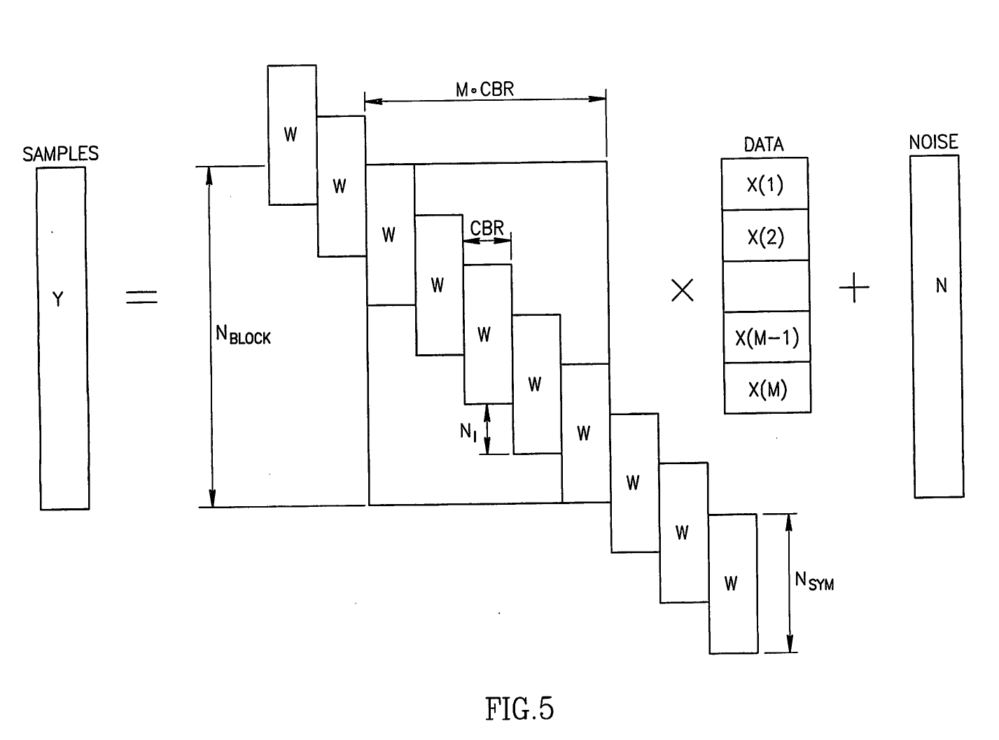

Due to the overlap in time between packets, a value of a packet is affected by inference with preceding and following packets. FIG. 5 shows a modeling of this behavior in accordance with an exemplary embodiment of the invention. A set of real samples Y is generated by the real-world equivalent to mathematically adding a noise vector N to the multiplication of a data vector X(1 . . . M) by a meta matrix comprised of components W that indicate the interaction between symbols and samples. Since the overlap is not limited in time, sample vector Y and the meta matrix are infinite. In an exemplary embodiment of the invention, however, part of the matrix is used at a time, which part can be used to estimate the values for at least most of the values in X. In an exemplary embodiment of the invention, for a vector of M elements, the meta matrix section selected has M matrixes W arranged in its diagonal, in an overlapping manner (in height=time).

Each component matrix W has a width of CBR (the common chip rates in a bit) and a height of N_{sym}, which is the number of chips (or, in some embodiments, for example if over-sampling is practiced, samples) in a overlap set of chips (e.g., of duration T_{sym}). The matrixes are displaced by N_{I}, which is the real number of chips (or samples) in a single packet. It should be noted that in a single system, different packet sizes may be used and this may be provided for in some embodiments of the invention. Optionally, N_{I} is the number of chips in the smallest packet size (e.g., typically data packets as opposed to voice packets).

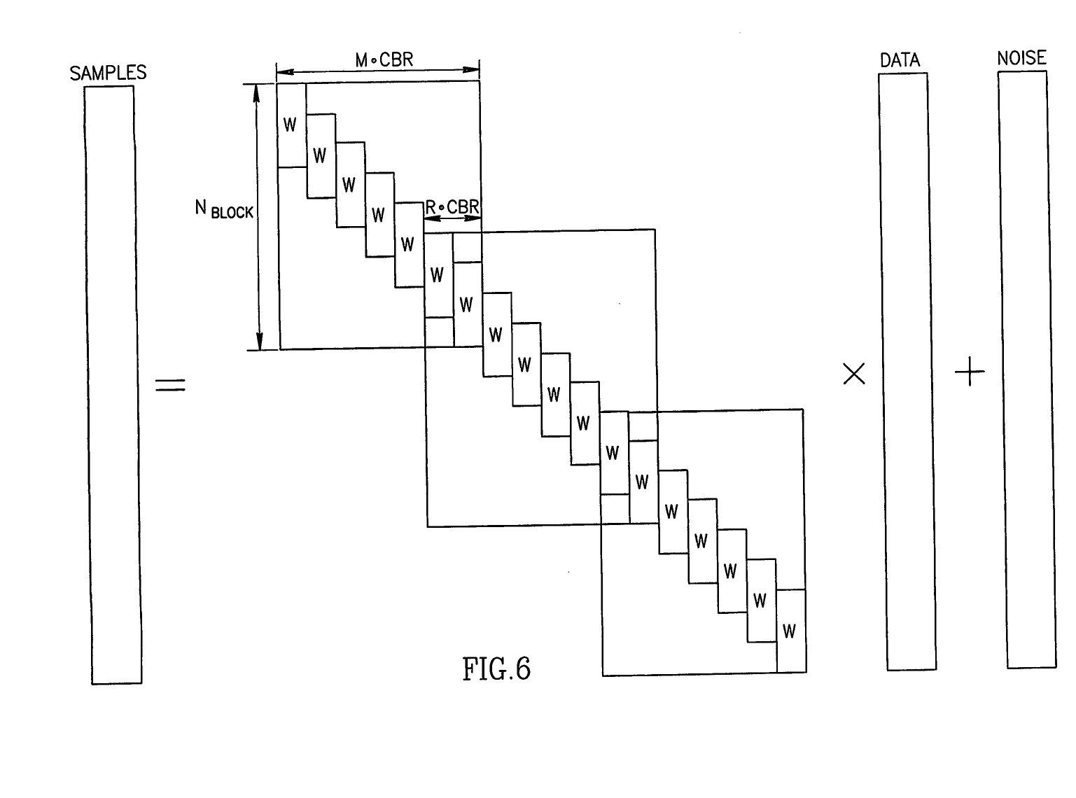

The first and last bits, however, are evaluated with an incomplete overlap. In an exemplary embodiment of the invention, the last bit is used as the first bit in the next calculation, so that the overlap is provided. the results of this next calculates are optionally used to provide a final value for the “last bit”. FIG. 6 shows such overlap, in which a redundancy of R (the number of overlapping matrixes W and packets assumed, not to be confused with the matrix R of Eq. 2) determines the degree of overlap between the meta matrixes. In an exemplary embodiment of the invention, after each set of data X(1 . . . M) is calculated, the last R bits are dropped, as they were calculated with insufficient overlap, instead, the next R bits from the next calculation are used. The first R bits are usually part of a training system. the final R bits usually have a lesser problem since they are part of a sign-off sequence and/or have no data after them, so there is less interference. In an exemplary embodiment of the invention, the contribution of the before-last R bits are used for calculating a next set of values. For example, the effect of these before-last R bits are estimated by multiplying them by A and the result is subtracted from the new set of samples Y.

It should be noted that in some cases these before-last R bits can have two types of contributions, one is contribution of known bits and the other is contribution of bits whose exact value is unknown. The number of overlapping bits R may be more than one, for example, two or three.

While this description has assumed that W is constant, this need not be. Each line in W is generally defined as the code sequence for a channel multiplied by a channel response. As the channel response changes, these lines change. For example, W can be changed over time as described above for A. However, this is not expected to much affect the overlapping sections, at least in some embodiments of the invention.

The data vector X may include, for example, data from multiple antennas, for example interleaved or arranged in series. In an exemplary embodiment of the invention, this enables the method using matrix W to operate as a smart antenna. In an exemplary embodiment of the invention, a SDMA protocol is provided by using the above multi-user separation method to separate out the spatial effects of multiple users.

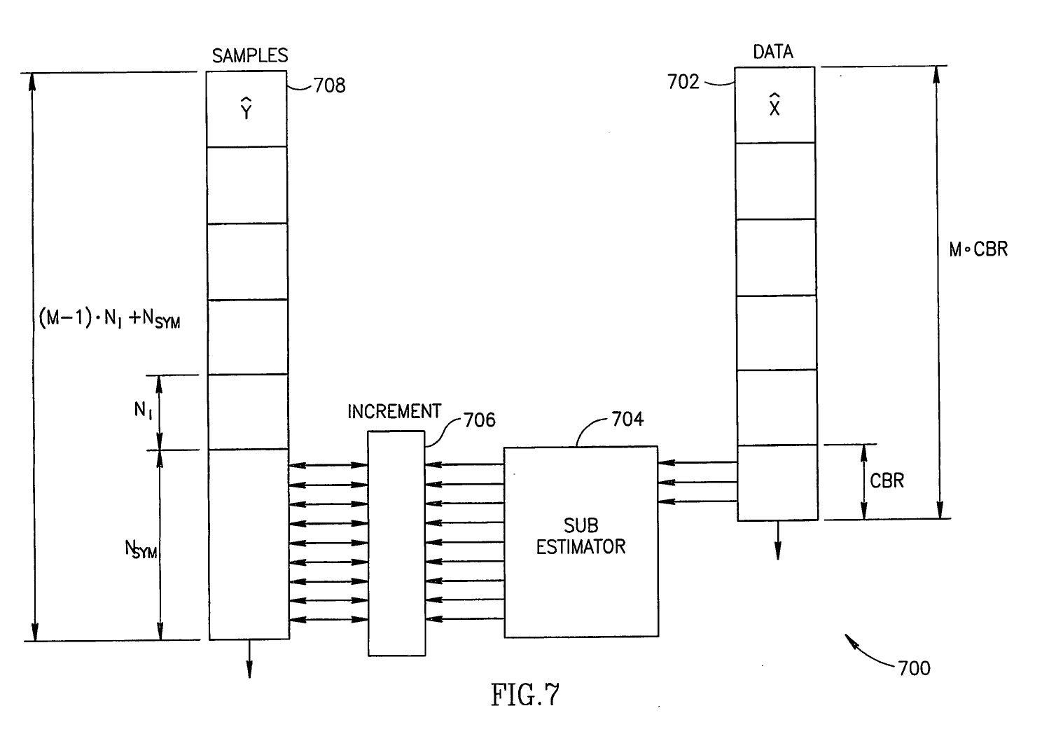

Referring back to FIG. 4, FIG. 7 shows a sample estimator 700, for example for use as unit 410, in accordance with an exemplary embodiment of the invention. An estimated data vector 702, having M times CBR chips is processed one CBR section at a time by a sub estimator 704. The results of sub estimation are incremented into a set of samples of size N_{sym}, by an incrementor 706. This set of samples is then used for estimating a new data vector \hat{X}. It should be noted that since, in some embodiments of the invention, matrix A is a repeat of matrixes W, sub-estimator 704 only needs to calculate the effect of the W components of the matrix. These effects can then be accumulated as shown.

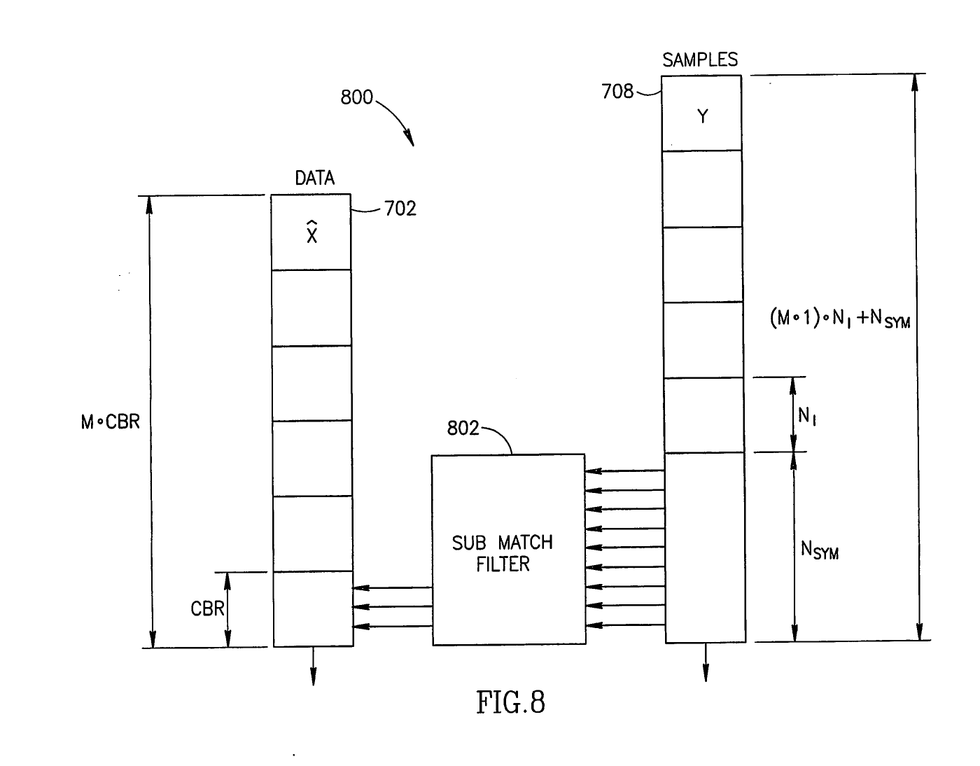

FIG. 8 is a schematic illustration of a match filter 800, for example for use as unit 408 of FIG. 4, in accordance with an exemplary embodiment of the invention. A set of input samples 708, is filtered by a sub match filter 802, one set of N_{sym} chips at a time, to generate one CBR of data bits.

For both FIG. 7 and FIG. 8, as shown, the actual data and sample vectors are infinite, and are calculated in parts (optionally overlapping as described above).

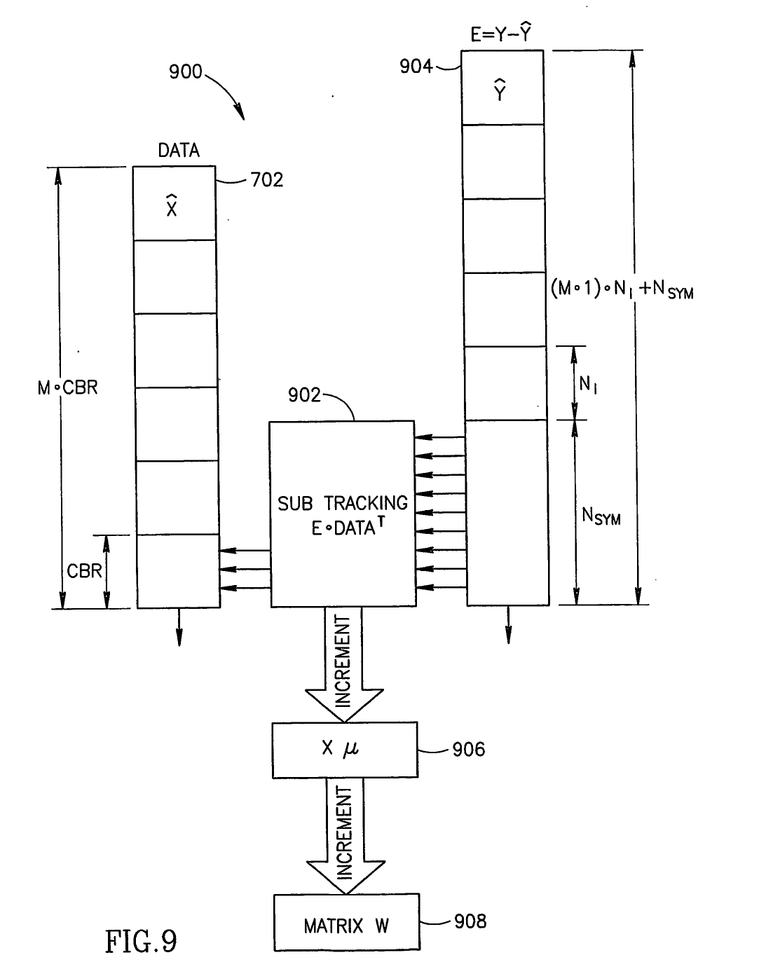

FIG. 9 is a schematic illustration of a tracker 900 for A, in accordance with an exemplary embodiment of the invention. An E vector 904 and a reference data vector 702 are used as shown in FIG. 3, for example, to calculate a new matrix A. The calculation is performed using a sub tracker 902, a multiplier 906 (for multiplying by a factor between 0 and 1) and then finally added into a matrix W (908). Since A is compose of multiple W matrixes, the tracking process needs be applied only on one component W. In this case, W is updated only once per input sample set. Alternatively or additionally, W may be updated also within a sample set.

It should be noted that matrix A is assumed to change slowly and what is actually provided as a result of the tracking is a low-pass filtered version of the “real” coefficient matrix. If there is a large change in A, it may be desirable, in some embodiments of the invention, to detect and/or correct this change in a separate manner. In an exemplary embodiment of the invention, some or all of such jumps are detected by the tracker or other elements of system 400 indicating that they is not converging fast enough and/or based on a size of error detected. Alternatively or additionally, some jumps may be pre-determined, for example, when a new mobile telephone user is added. In an exemplary embodiment of the invention, if the error can be identified as relating to a particular user (e.g., related to certain lines in the matrix), that user is re-registered in order to obtain the information required for correction. Alternatively, other matrix correction methods that may be known in the art may be used.

The above description has provided a system that may be used for many applications where a gradient G needs to be found and/or used for finding a maximum likelihood solution. In an exemplary embodiment of the invention, the methods and apparatus are used for a CDMA system, in which matrix W is a convolution of c and H, where c is a fixed user code and H is a varying user channel impulse response. Thus, in some parts of the system, for example, the tracker, the match filter and the estimator, calculations may be done on c, with the effect of H added after the fact. As will be shown, this may assist in reducing the size of matrix which needs to be loaded, which, in systems where matrix loading time is long (e.g., some optical systems), can provide a considerable saving of time. This type of separation may also be applied to other specific applications, for example DSL (digital subscriber lines), where the cross-talk between lines and the encoding of a line also have this property. Another possible application is SDMA and smart antenna applications (for CDMA and non-CDMA applications). It should be noted that in the CDMA context, the match filter functionality is sometimes called de-spreader or rake receiver.

A match filter is defined as:

$$X ( k ) = {\sum }_{n = 0}^{2 N \cdot OS - 1} W ( n , k ) \cdot Y ( n )$$

, where: N is the number of chips in a symbol (e.g., N=256), OS is the over sampling ratio (e.g., 4 samples in a chip), n is a sample index and k is a user index. W is the channel sub-matrix, which is a convolution between the impulse response H and the code matrix C. C is 2N long, but (at least) has N “zeros”

$$W ( n , k ) = {\sum }_{i = 0}^{i = M} H ( n , k ) \cdot C ( \frac{n - i}{OS} , k )$$

, where M is the maximum length of the multipath

These equations are optionally expanded so that they are more suitable for a particular implementation, for example, taking into account one or more of:

1. What type of operation can be performed efficiently (e.g., vector operations in a VMM are fast, matrix changes are not).

2. Limitations on dynamic range (e.g., 8 bits, so a matrix with only −1, 0 and +1 are used in one example).

3. Simplifying assumptions (e.g., tracking is on a “smoothed” version H′ of the impulse response H, rather than on W). for a time k measured in units of oversampling 0 . . . OS−1, H′(j,k)=H(j,k)+H(j,k+1)+H(j,k+2)+H(j,k+3); for OS=4.

The same or other issues and assumptions may be used for other specific implementations.

$$\begin{matrix}X ( k ) = {\sum }_{n = 0}^{2 N \cdot OS - 1} {\sum }_{i = 0}^{M - 1} H ( i , k ) \cdot C ( \frac{n - i}{OS} , k ) \cdot Y ( n ) \\ = {\sum }_{i = 0}^{M - 1} H ( i , k ) \cdot {\sum }_{n = 0}^{2 N \cdot OS - 1} C ( \frac{n - i}{OS} , k ) \cdot Y ( n )\end{matrix}$$

, which is H*(C.Y)

Now one can use the fact that the codes “C” do not change for OS samples:

$$\begin{matrix}X ( k ) = {\sum }_{i = 0}^{M - 1} H ( i , k ) \cdot {\sum }_{n = 0}^{2 N \cdot OS - 1} C ( \frac{n - i}{OS} , k ) \cdot Y ( n ) \\ = {\sum }_{i = 0}^{M - 1} H ( i , k ) \cdot {\sum }_{n = 0}^{2 N \cdot OS - 1} C ( \frac{n}{OS} , k ) \cdot Y ( n + i ) \\ = {\sum }_{i = 0}^{M - 1} H ( i , k ) \cdot {\sum }_{j = 0}^{OS - 1} {\sum }_{n = 0}^{2 N - 1} C ( n , k ) \cdot Y ( OS \cdot n + i + j ) \\ = {\sum }_{i = 0}^{M - 1} H ( i , k ) \cdot {\sum }_{j = i}^{i + OS - 1} {\sum }_{n = 0}^{2 N - 1} C ( n , k ) \cdot Y ( OS \cdot n + j )\end{matrix}$$

If one denotes the Vmm Output as: n=O

$$VmmOut ( j , k ) = {\sum }_{n = 0}^{2 N - 1} C ( n , k ) \cdot Y ( OS \cdot n + j ) ,$$

then

$$\begin{matrix}X ( k ) = {\sum }_{i = 0}^{M - 1} H ( i , k ) \cdot {\sum }_{j = i}^{i + OS - 1} {\sum }_{n = 0}^{2 N - 1} C ( n , k ) \cdot Y ( OS \cdot n + j ) \\ = {\sum }_{i = 0}^{M - 1} H ( i , k ) \cdot {\sum }_{j = i}^{i + OS - 1} VmmOut ( j , k ) , then \\ X ( k ) = {\sum }_{i = 0}^{M - 1} H ( i , k ) \cdot {\sum }_{j = i}^{i + OS - 1} VmmOut ( j , k ) \\ = {\sum }_{j = 0}^{M + OS - 1} VmmOut ( j , k ) \cdot {\sum }_{i = 0}^{OS - 1} H ( i + j , k ) \\ = {\sum }_{j = 0}^{M + OS - 1} G ( i , k ) \cdot VmmOut ( j , k ) , where \text{:} \\ G ( j , k ) = {\sum }_{i = 0}^{OS - 1} H ( i + j , k )\end{matrix}$$

is Convolution of H with a single chip (i.e., a channel impulse response in relevant bandwidth).

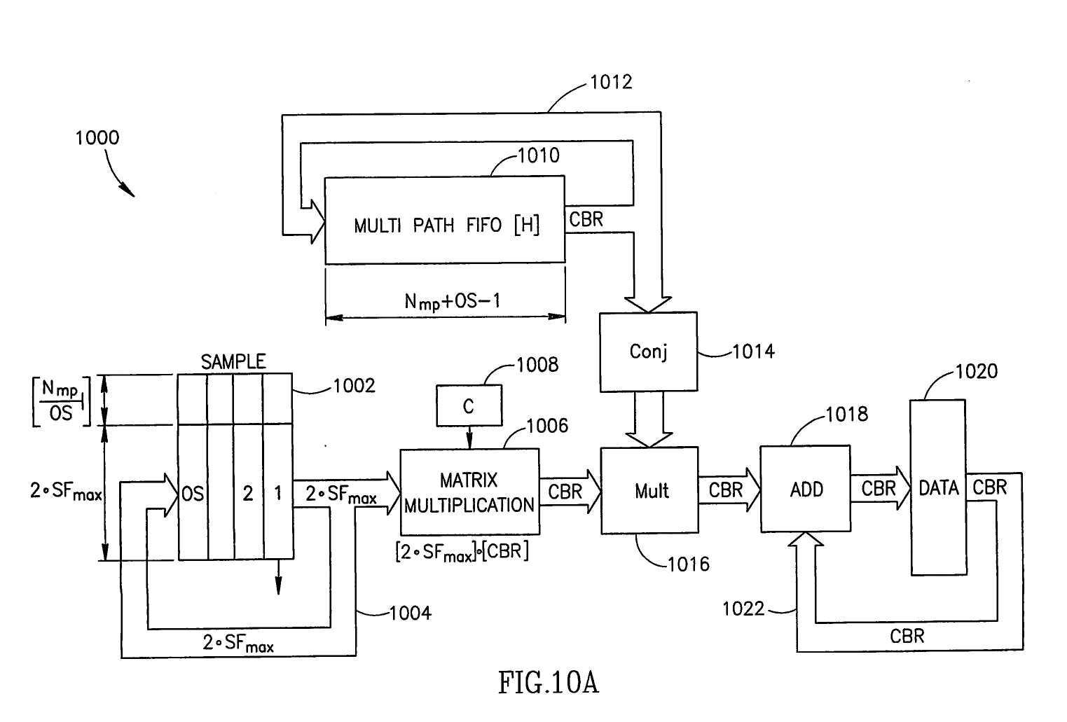

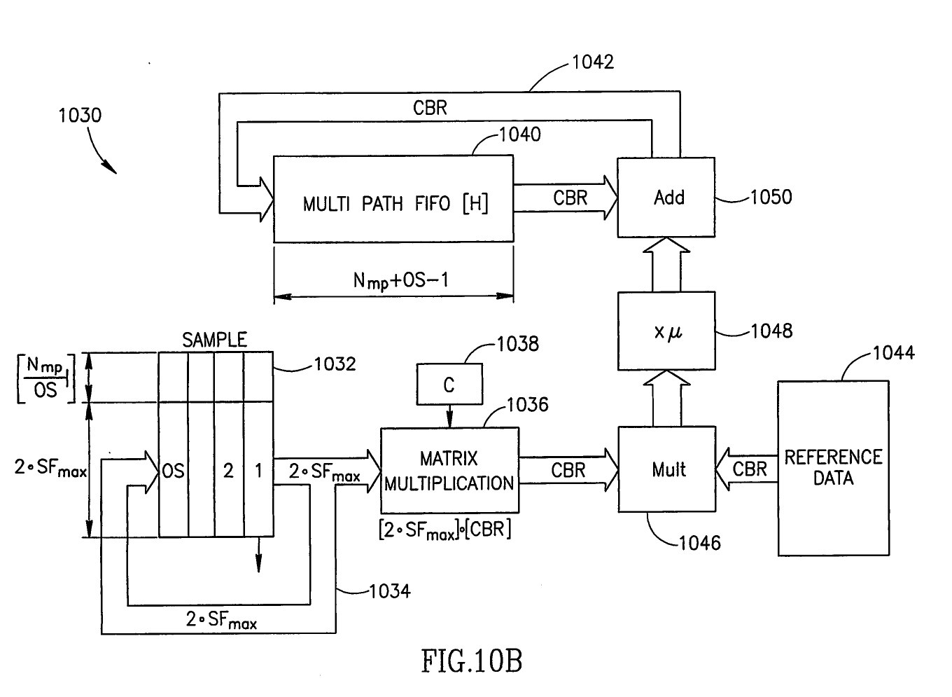

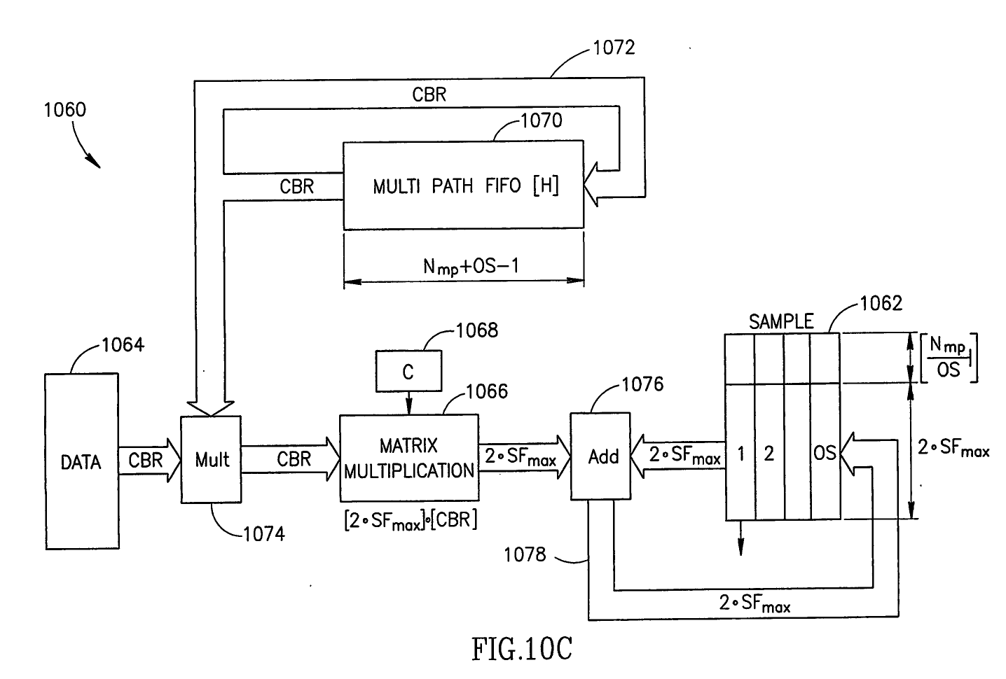

FIG. 10A is a schematic data flow drawing of a convolution based implementation of a match filter 1000 following the foregoing mathematical analysis. Example code for carrying this out is shown in table III, below. Data is stored in a sample array 1002, with each column indicating one set of over-sampling. At each processing cycle, one vector of 2*SFmax bits is taken out of the array for processing. An arrow 1004 indicates that the samples are not deleted, but that the sample array is shifted. The data vector is then multiplied by matrix C, the code matrix, at a multiplier 1006 (e.g., as a vector matrix multiplication step). This matrix may be changed, for example as indicated by unit 1008. Element 1010 indicates a storage of matrix H, from which a line of length CBR is retrieved each cycle. Element 1010 is shifted after each such retrieval, as indicated by an arrow 1012. The matrix line is conjugated by a conjugator 1014 and then multiplied, element by element with the result of 1006, by a multiplier 1016. The result of the multiplication is accumulated using an adder 1018 and a data store 1020, with an arrow 1022, indicating the accumulation.

FIG. 10B is a schematic data flow drawing of a convolution based implementation of a tracker 1030. Example code for carrying this out is shown in table IV, below. Data is stored in a sample array 1032, with each column indicating one set of over-sampling (e.g., h′(t)=h(t)+h(t+1)+h(t+2)+h(t+3)). Optionally, the vector of measured samples, optionally after subtracting the estimated signal, is rearranged (to simplify the calculations) as four vectors:

Y′1={Y′(1), Y′(5), . . . Y′(4n+1)}

Y′2={Y′(2), Y′(6), . . . Y′(4n+2)}

Y′3={Y′(3), Y′(8), . . . Y′(4n+3)}

Y′4={Y′(4), Y′(9), . . . Y′(4n+4)}

At each step k, a sub vector is selected by choosing 2*SFmax consecutive elements from these vectors: Y′1(k)={Y′1(k), Y′1(k+1), . . . Y′(k+2*SFmax )}, where SFmax is the maximum number of samples in a super finger (a set of inter-related signals and their echoes, as described below), or the maximum number of samples that are chosen to include the useful information due to multiple path delay. An arrow 1034 indicates that the samples are not deleted, but that the sample array is shifted.

These sub vectors, Y′1(k), Y′2(k), Y′3(k), Y′4(k) are multiplied sequentially by the matrix of codes C (optionally by a VMM module, 1036). This matrix may be changed, for example as indicated by unit 1038. The resulting vector (with length CBR; where CBR is the number of data bits) is element by element multiplied by a vector of data (e.g., as determined by the logic after the previous iteration, 1044) to form an adaptation vector dh′(j,k). dh′(1,k)=Data·[Y′1(k)*C]; where “*” is a vector matrix multiplication operation, “·” is an element by element multiplication (optionally done by a vector processing unit) and “Data” is the vectors of the data. Optionally, the “Data” has values of {−1, 0, +1} where “0” stands for data that was detected with low confidence level. Alternatively, “Data” may take values more continuously related to the confidence level of detection.

The resulting vector dh′(j,k) is used to adapt the matrix h′(j,k) (1040), using an adder 1050, according to:

h′new(j,k)=h′old(j,k)+μdh′(j,k)

,where h′(j,k) is the smoothed matrix of channel impulse response and μ (1048) is the convergence factor. Arrow 1042 indicates cycling the results into matrix store 1040.

FIG. 10C is a schematic data flow drawing of a convolution based implementation a signal estimator 1060. Example code for carrying this out is shown in table II, below. Data is provided by an element 1064. At each processing cycle, one vector of CBR elements is taken out. At the same time, a line from a matrix H (1070) is cycled out, and the matrix shifted, as indicated by an arrow 1072. A multiplier 1074 multiples the matrix line by the data. The result of this multiplication is multiplied by a matrix c (1068) at multiplier 1066. The result of this multiplication is accumulated into a sample array 1062, using an adder 1076 and a shifter 1078 that cycles the sample array.

Table I shows global parameter definitions for an implementation of an estimator, a tracker and a match filter, in accordance with an exemplary embodiment of the invention

TABLE I
Global Parameters

| | |
|---|---|
| global M; | % Number of Packets in Block |
| global CBR; | % Common Bit Rate |
| global OS; | % Over Sampling relative to Tchip [Time of Chip] |
| global SFmax | % Maximal Spreading Factor |
| global Nmp; | % Multipath Length |

global Ni = OS * SFmax;
global Nsym = 2*Ni + Nmp;

| | |
|---|---|
| global W; | % Basic Matrix |

% W. basic = conv (W.Code, W.Multipath)
% Dimension - Nsym by CBR

| | |
|---|---|
| % Where: | W.Code - Code Matrix with Sampling Tchip |
| % | Dimension - 2*SFmax by CBR |
| % | W.Multipath - Convolution of Channel Impulse Response |
| | with Chip |
| % | Dimension - CBR by Nmp |

| | |
|---|---|
| global mu; | % Tracking Convergence Coefficient |

Table II shows exemplary MatLab code for performing interference estimation in accordance with FIG. 7.

TABLE II
Interference Estimation

```
function Sample = InterferenceEstimatorConv(Data);
Sample = zeros(1:(M−1)*Ni+Nsym,1);
for j=0:M−1;
  for i=1:Nmp;
    R = W.Multipath(:,i).*Data(j*CBR+1:j*CBR+CBR)
    Sample(j*Ni+1:j*Ni+Nsym) = Sample(j*Ni+1:j*Ni+Nsym) +
    W.Code * R;
  end
end
```

If over sampling is used, each column comprises each chip repeated the number of times of the over-sampling. The implementation performs c*X and then adds the effect of H and oversamples (or first oversamples and then adds the effect of H).

Table III shows exemplary MatLab code for performing match filtering in accordance with FIG. 8.

TABLE III
Match Filter

```
function Vout = MatchFilterConv(Sample);
Vout = zeros(1:M*CBR,1);
for j=0:M−1;
  for i=1:Nmp;
    R = transpose(W.Code) * Sample(j*Ni+i:j*Ni+i+Nmp);
    Vout(j*CBR+1:j*CBR+CBR) = Vout(j*CBR+1:j*CBR+CBR) +
real(conj(W.Multipath(:,i)). * R);
  end
end
```

In this unit, the repetition of the matrix are in the rows, with chips being repeated in a row due to the over-sampling.

Table IV shows exemplary MatLab code for performing a learning of a matrix W, in accordance with an exemplary embodiment of the invention.

TABLE IV
TRACKER

```
function Vout=TrackerConv(SampleError,DataRef);
Vout = zeros(1:M*CBR,1);
for j=0:M=1;
  for i=1:Nmp;
    Error = transpose(W.Code) * SampleError(j*Ni+i:j*Ni+i+Nmp);
    W.Multipath(:,i) = W.Multipath(:,i) + mu * Error *
conj(DataRef(j*CBR+1:j*CBR+CBR));
  end
end
```

While this unit shows only learning of H (c is known), optionally, both c and H are learned, separately or as a single unit. In an exemplary embodiment of the invention, matrix c is padded with zeros so that it fills up the VMM. It is noted that since the operations are performed in parallel, this might not be a significant hardship.

In a standard CDMA implementation, it is recommended to provide several fingers of a rake receiver, with each finger being used to provide an analysis of one possible “main” echo in a signal. Typically, a small number of fingers are provided, such as 2 or 3. In an exemplary embodiment of the invention, many such fingers are provided. However, in some implementations, the cost of changing the matrix makes it difficult to deal with “fingers” that are substantially delayed in time. One solution is to increase the matrix size or provide a fast shifting capability in the matrix. Another solution is to reduce the matrix resolution. In an alternative embodiments of the invention, it is noted that often several echoes have a short range of delays. Each such set of echoes can be processed using a single (optionally oversized) matrix, with the data and/or matrix shifted to account for the delay. In an exemplary embodiment of the invention, each such matrix and associated set of echoes is termed a “super finger”. A plurality of such super fingers may also be provided, for example by changing the matrix. Optionally, search algorithms, auxiliary to the MUD systems are used to assist in determining the clumping together of echoes and user signals.

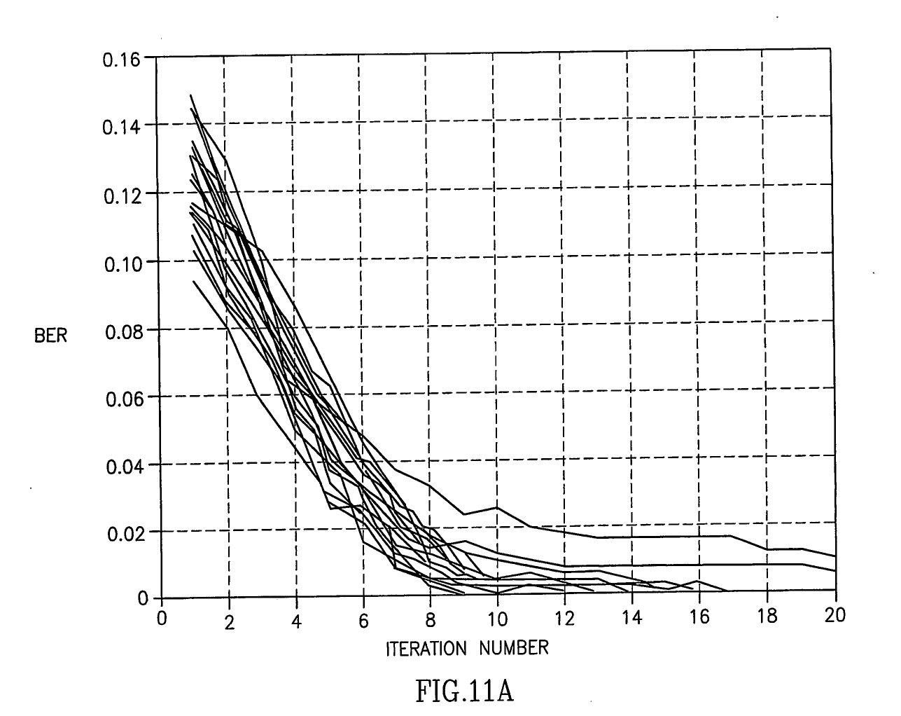

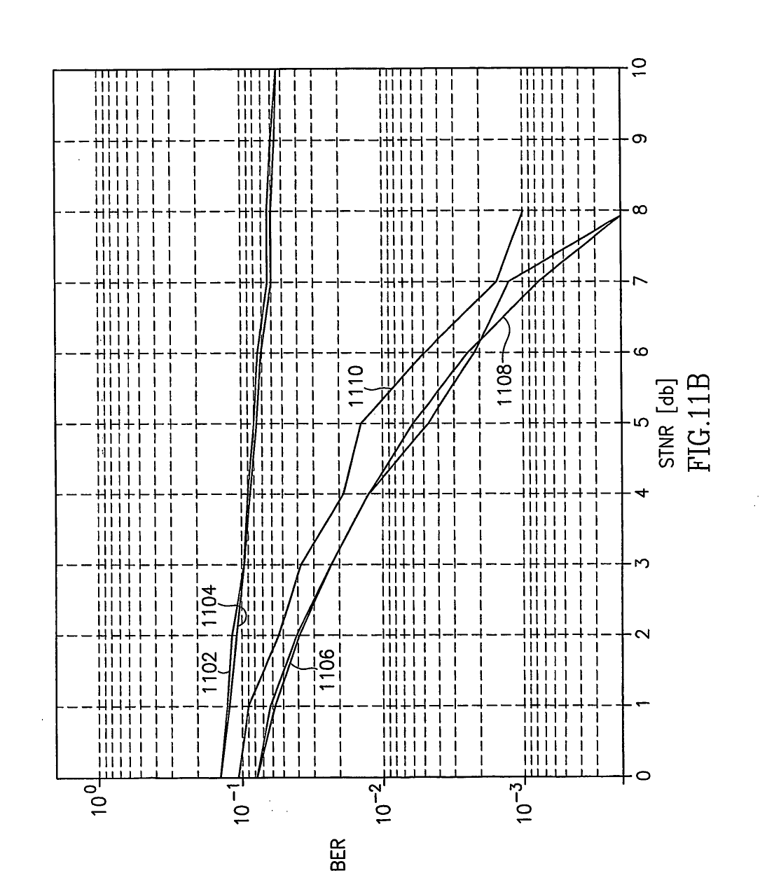

Some simulations were executed for this implementation, and their results are shown in FIGS. 11A and 11B. FIG. 11A is a graph showing the number of iterations required for convergence to within a desired bit error rate, as results of a simulation in accordance with an exemplary embodiment of the invention. This simulation assumes 256 different users. As can be seen, a small number of iterations is generally sufficient. In the two cases shown where it is not, solving a following, overlapping block of samples should solve the problem.

FIG. 11B is a graph showing a comparison between theory and practice for a plurality of signal separation methods and a method in accordance with an exemplary embodiment of the invention, under a range of signal to noise ratio situations. As shown, a line 1102 shows a simulation of a 128 user rake receiver method. A line 1104 shows a theoretical result for this case. As can be seen, the bit error rate does not significantly go down even if the signal to noise gets better, this is probably because of a predominance of inter-user interference. A line 1106 shows simulation and a line 1108 shows theoretical results for a single user case of a rake receiver. In contrast, a line 1110 shows a multi-user detection method in accordance with an exemplary embodiment of the invention, showing results that are comparable to a single user rake receiver, even though 128 users are actually being simulated.

These methods may be applied using various types of hardware and software. In an exemplary embodiment of the invention, an optical or electronic vector matrix multiplier is used. One exemplary optical vector matrix multiplier is shown in Israel application number 145245, filed Sep. 3, 2001, the disclosure of which is incorporated herein by reference. While this is not the only possible implementation, an advantage of vector matrix multipliers is that they may be able to benefit from the replacement of matrix-matrix multiplications with matrix vector multiplications. A PCT application filed in the IL receiving office on even date with this application, having attorney docket [141/02683] and titled “Vector-Matrix Multiplication” describes various architectural details for such an optical VMM. A US application filed on even date with this application, having attorney docket [141/02681] and titled “Digital to Analog Converter Array” describes additional details. The disclosure of these applications is incorporated herein by reference. Alternatively the implementation may be as software which can run on a general purpose computer or which may be adapted to a special type of computer, for example a vector processor.

Some mathematical analysis may be found in Israel application 150133, the disclosure of which is incorporated herein by reference.

Now, a particular example of applying MUD in accordance with an exemplary embodiment of the invention, will be described. The specific numbers and other details numbers should not be considered limiting to other embodiments or implementations of the invention.

First, the code matrix is constructed. This matrix, Code(j, user), has dimensions of 512×2*CBR. Each real user is represented by one control bit and 256/SF data bits. Thus, the number of virtual users is given by:

$$CBR = \# of users + {\sum }_{all users} 256 / {SF}_{user}$$

The codes contains real and imaginary values.

The matrix is separated to its real and imaginary parts: ReCode and ImCode, each 512*CBR in size. For CBR<256, some of the rows are empty, for CBR>256, the ReCode and ImCode must be split for a 256*256 matrix. Each row (512 in length) represents the code of one virtual user at chip resolution, delayed by the number of chips that were determined during the delay search of the acquisition stage. The row starts with as many zeros at the delay, followed by the values according to the code (at least four elements for the shortest spreading factor and maximum 256 values for SF=256 and for the control bits). For a VMM with matrix size of 256×256, each of the matrixes of codes must be represented by at least two matrixes. If the number of virtual users is less then 128, some of the rows are just zeros. If 2*CBR>256, more matrixes are prepare to hold the values.

The standard requires that the energy received at the antenna for each chip will be the same. Two mechanisms enable it:

(a) Automatic power control that equalize the received signal from all users by controlling their transmission power.

(b) Increasing the transmission power to reflect the spreading factor.

Thus, the energy per chip in a bit transmitted at SF=4 is 64 times larger then the energy per chip in a bit transmitted at SF=256. The energy is proportional to the square of the signal. Thus, the signal strength of a chip in a bit transmitted at SF=4 is 8 times larger then the that of SF=256.

In an exemplary embodiment of the invention, to take full advantage of the limited dynamic range of the optical; VMM, it may be desirable to arrange that the results of the vector matrix multiplication would be similar. Optionally, the following translation table is used, in which the original code values are +/−1, +/−j. The range of values in the VMM matrix is +/−128.

| SF | Value |
|---|---|
| 4 | 128 |
| 8 | 91 |
| 16 | 64 |
| 32 | 45 |
| 64 | 32 |
| 128 | 23 |
| 256 | 26 |

Then, the matrix of multi-paths H, is prepared. The values in this matrix are optionally measured during the Acquisition stage (of a new user) and may be updated during the tracking process (if selected). This matrix consists of SFleng pairs of vectors ReH[k] and ImH[k] for the real or imaginary parts. The number of elements in each vector is equal to the number of virtual users, CBR.

Then, an accumulator is initialized for the results of the estimated samples. This accumulator, Ye(t), is in two vectors: ReYe[t] and ImYe[t] for the real and imaginary elements of the vector, and may include 2*[(M+l)*256*OS+SFleng] elements. All values are set to zero.

In an estimator loop, there are two nested loops:

(a) Main loop over all the data packet X in the block (which contains M packets)

(b) Internal loop over all the possible echoes that are within the acceptance of the super finger (SFleng)

The operations are done separately for real and imaginary parts of the variables due to the physical limitations of the hardware. Additionally, due to the limited size of the optical VMM, the matrix multiplication is done in at least two parts. If 2*CBR>256, the vector matrix multiplication will be done in four parts.

The loop over all the data packets X(m) for m={1,2, . . . , M}, is as follows. The process contains following parts which are made in sequence and repeated for all the vectors H[k, c] for K={1, 2, . . . SFleng}: and c={Re, Im}.

1. Element by element Multiplying the vector X with the vector H. If BPSK coding is used, each data packet X is a vector containing the CBR elements, each with value +1 or −1.

In this case, this vector is multiplied element by element with

(a) Real part: ReHX=X*H[k,Re]

(b) Imaginary part: ImHX=X*H[k,Im]

If X is complex such as in QPSK coding, multiplication of complex vector with complex vector is performed. This is done by expressing the complex vector as vector of real part and a vector of the imaginary parts and performing:

ReHX=ReX*ReH−ImX*ImH, InHx=ReX*ImH+hnX+ReH.

2. Rearranging of Vector HX. Alternatively, the matrix of code could be arranged as ReCode and ImCode. Then at least 8 VMM operations are needed (but CBR can be as big as 256 instead of 128). For CBR<128, two VMM operations are needed for the real and two for the imaginary parts (this is due to the width of the VMM=256 and the length of the code=512). So total VMM operations is 4 for each estimation (at CBR<128).

For CBR>128, the ReCode and hiCode may be simpler as it avoids the operation of “add near elements” that is needed for QPSK

A vector of length 2*CBR is constructed by arranging the elements of ReHX and ImHX in the following way:

HX={ReHX(1), −Im(1), ReHX(2), −ImHX(2), . . . }

3. Vector Matrix Multiplication of HX with matrix of codes.

ReCodeHX=HX*Code

The result is a vector with 512 elements. it should be noted that the way HX is arranged makes the elements of ReCodeHX the sum of Re*Re−Im*Im. In a particular implementation, the first 256 elements are done first (for all k's) then the loop is repeated for the second half. This way, rapid matrix exchange is optionally avoided.

4. Accumulation of the result of ReCHX into the accumulator ReY. This may be done by arranging Y(t) as four complex vectors:

Y1(t), . . . Y4(t) so that Y1(t)={Y(1), Y(5), } etc.

This way, there is no decimation and expansion, only accumulation into the appropriate vector.

5. Rotation of Vector HX by 90 deg. This is an operation on the complex vector HX in which,

HX={ReHX(1), −ImHX(1), ReHX(2), −ImnHX(2), . . . } is rearranged as HX′={ ImHX(1), ReHX(1), ImHX(2), ReHX(2), . . . }

6. Vector Matrix Multiplication of HX with matrix of codes ImCHX=HX′*Code It should be noted that the way HX′ is arranged makes the elements of ImCodeHX the sum of Re*In+Ihn*Re

7. Accumulation of the result of ImCHX into the accumulator ImY. This is the same as in #4.

8. Advancing the vector Y and then returning at 1. This continues for all k={1,2, . . . , SFleng}

Then the entire loop is repeated (from the loop over the data packets).

The effect of a previous processed block is then added.

As noted above, the VMM matrix is only 256 long. Thus, the multiplication of Code x Y[k] is done in two operations. Y[k] is cut into two halves, each with 256 elements and similarly the Code matrix is divided to two matrixes each 256×“number of users” in size. It should be noted that that the result of Code×Y[k] remains a vector with length equal to the number of virtual users. Since the physical act of changing the matrix within the optical VMM core may be relatively time consuming, all the first halves of the vectors are multiplied and accumulated first. Then the second half of the Code matrix is loaded and the loop continues for all the second halves of Y[k].

The result of the accumulator is then reported. If the system is using BPSK (Binary Phase Shift Key), then only the real part is calculated and reported. If the system is using QPSK (Quadrature Phase Shift Key), then both real and imaginary parts are calculated and reported. Thus, input signals generated by a plurality of users are acquired using antenna, processed and then used to reconstruct sets of data signals, each of which may then be forwarded to other users for example to be sounded using speakers. Other uses of the data may be provided, for example for other applications.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of finding a maximum likelihood solution vector for a sample vector, comprising:
providing a sample vector;
iteratively match-filtering said sample vector with a coefficient matrix to find a gradient;
using the gradient to search for a maximum likelihood solution vector; and
deciding if a found solution vector is good enough.

2. A method according to claim 1, wherein deciding comprises deciding using a soft decision method

3. A method according to claim 1, wherein said solution is used to solve a multi-user detection (MUD) problem.

4. A method according to claim 3, wherein said MUD is for cellular telephony.

5. A method according to claim 1, wherein said vector includes contributions from at least 20 independent signal sources.

6. A method according to claim 5, wherein said at least 20 independent signal sources comprises at least 40 such sources.

7. A method according to claim 5, wherein each of said sources provides at least two dependent signals.

8. A method according to claim 5, wherein each of said sources provides at least three dependent signals.

9. A method according to claim 1, wherein said searching uses frustrated convergence.

10. A method according to claim 1, wherein said method uses less than o(n\hat{ }3) operations, where n is the size of the sample vector.

11. A method according to claim 1, comprising tracking changes in said coefficient matrix.

12. A method according to claim 1, comprising estimating a signal using said coefficient matrix.

13. A method according to claim 1, wherein match-filtering comprises match-filtering using vector-matrix multiplication.

14. A method according to claim 13, comprising arranging said data to fit a specific hardware adapted for vector matrix multiplication.

15. A method according to claim 14, wherein comprises arranging said data in a manner which minimizes matrix replacements.

16. A method of separating out, from a set of samples, signals that are unsynchronized and include echoes and/or other inter-symbol interference, comprising:
first processing a first portion of said samples to yield a first set of values for said signals, at least one of said values not being decidable from said samples;
second processing a second, overlapping portion of said signals to yield a second set of values for said signals, said second processing taking into account said first set of values to correct for an effect of echoes of said first set of values on said second set of values,
wherein each of said processings is pinned as a simultaneous block processing.

17. A method according to claim 16, wherein processing comprises multiplying by a coefficient matrix.

18. A method according to claim 17, wherein the same matrix is used for both processings.

19. A method according to claim 17, wherein an updated matrix is used for the second processing.

20. A method according to claim 16, wherein said values are encoded as a series of chips in said signals.

21. A method according to claim 16, wherein said signals are CDMA cellular telephone signals.

22. A method according to claim 20, wherein not all signals use the same number of chips to encode a value.

23. A method of tracking a coefficient matrix, comprising.
providing a coefficient matrix;
calculating an error vector for a data vector X, when using said coefficient matrix; and
calculating a correction matrix to be a product of a conjugation of said error vector and of a transpose of said data vector X;
setting a new value of said matrix to be an element by element sum of old values of said coefficient matrix and said correction matrix, said correction matrix being multiplied by a correction factor beta.

24. A method according to claim 23, wherein at least one of said data vector X and said error vector is substituted by a sign vector of their values.

25. A method of matrix tracking, comprising:
providing a coefficient matrix;
using said matrix to extract at least an indication of a data vector from a set of samples, by performing a vector multiplication;
determining an error vector of said use of said matrix, using said indication; and
correcting said matrix using said error vector.

26. A method according to claim 25, wherein said indication comprises a gradient.

27. A method according to claim 25, wherein said indication comprises said data vector.

28. A method of using a coefficient matrix for extracting signals where each signal is encoded using a set of chips and oversampled, comprising:
separating a coefficient matrix into a changing coefficient matrix that includes the inter-signal dependencies and a fixed code matrix which provides over-sampling;
applying a desired processing that requires vector matrix multiplication, using said fixed code matrix; and
perfecting the desired processing by applying said changing coefficient matrix on an element-by-element basis.

29. A method according to claim 28, wherein said desired processing comprises signal estimation based on a provided data vector.

30. A method according to claim 28, wherein said desired processing comprises match filtering of a sample vector.

31. A method according to claim 28, wherein said desired processing comprises updating said coefficient matrix.

32. A method according to claim 28, wherein said perfecting comprising applying said changing coefficient matrix on a result of said vector matrix multiplication.

33. A method according to claim 28, wherein said perfecting comprising applying said changing coefficient matrix on a data vector used for said vector matrix multiplication.

34. A method according to claim 28, wherein said perfecting comprising updating said changing coefficient matrix using a result of said vector matrix multiplication.

35. A method according to claim 28, comprising providing a new set of data to be processed using said matrix, without updating said matrix as loaded in a vector matrix multiplier.

36. A method according to claim 28, comprising padding said fixed code matrix for use with a matrix—vector multiplier.

37. A method according to claim 36, comprising weighting said fixed code matrix so that longer codes have a smaller weight than shorter codes.

38. A method according to claim 28, wherein said changing coefficient matrix represents changes in a physical channel of interactions between signal paths represented by said matrix.

39. A method of finding a set of signal values from a set of data vectors using a coefficient matrix consisting substantially of:
providing a set of samples; and
applying to said set of samples vector matrix multiplication and element-by-element multiplication and addition and no matrix-matrix multiplication or inversion.

40. A method of extracting data bits from a set of samples representing the contribution of multiple signal comprising:
selecting a block of samples; and
processing said block simultaneously to provide a plurality of bits of information for a plurality of signals.

41. A method according to claim 40, wherein said plurality of bits comprises over two bits.

42. A method according to claim 40, wherein said plurality of signals comprises over 10 distinct and substantially independent signals.

43. A method according to claim 40, wherein said plurality of signals comprises over 30 distinct and substantially independent signals.

44. A method according to claim 40, wherein at least two of said signals use different temporal lengths to encode said bits.

45. A method according to claim 40, comprising selecting a second block of overlapping samples and processing said block to provide a second plurality of bits of information for said plurality of signals.

46. A method according to claim 40, comprising:
dividing up input signals based on temporal clustering of the signals, such that each cluster can be processed by a single mar without requiring matrix changing for a particular hardware implementation; and
processing each such cluster separately.

47. A generalized gradient finding system, comprising:
an input which receives a set of samples;
a match filter which calculates a gradient based on a coefficient matrix inter-relating the signals that generated tho samples; and
a signal estimator which generates an estimated set of samples based on an implementation of said gradient on said samples.

48. A system according to claim 47, comprising a controller that applies a search method using said gradient.
